(19) United States
(12) Patent Application Publication
(10) Pub. No.: US 2026/0366335 A1
(43) Pub. Date: Nov. 19, 2026

(54) SUCCESSIVE-PRELOADING-RELEASE LOCK STRUCTURE

(71) Applicant: GIANNI INDUSTRIES INC., NEW TAIPEI CITY (TW)

(72) Inventor: Che-Ming CHANG, NEW TAIPEI CITY (TW)

(21) Appl. No.: 19/211,283

(22) Filed: May 19, 2025

(51) Int. Cl. E05B 47/00

(52) U.S. Cl. CPC E05B 47/0047; E05B 2047/0074

(57) ABSTRACT

A successive-preloading-release lock structure includes a housing having a receiving space and an auxiliary receiving space; an operation drive device arranged in the receiving space and including a control module that includes an output module and a solenoid valve electrically connected to the output module and including an extendible/retractable rod; a positioning member having a first end arranged in the auxiliary receiving space and including a first support shaft having a second end connected to the housing, the positioning member having a first stop; and a stopper member arranged in the receiving space and including a second support shaft having a third end connected to the housing, the stopper member having a second stop engageable with the first stop. The output module successively outputs pulses within one time period to cause the extendible/retractable rod to successively hit the first stop for multiple times.

### BACKGROUND OF THE INVENTION

### a. Technical Field of the Invention

The present invention relates to a lock, and more particularly to a successive-preloading-release lock structure.

### b. Description of the Prior Art

Taiwan Utility Model M345853 discloses an “electromagnetic door lock”. As depicted in FIGS. 1 and 2 of M345853, the electromagnetic door lock comprises a base plate, a plurality of positioning seats, a solenoid valve module, and at least one housing member. The base plate is provided on one side thereof with a through hole. When the circuit board is supplied with positive charges, the solenoid valve generates a combined magnetic force to attract the electromagnet core to move inward, and drive a transmission element to make a main axle extending through the base plate to the outside of the through hole for locking.

The “electromagnetic door lock”, although being effective for locking a door, is susceptible to influence by factors such as environment and deformation resulting from long term operation, causing the lock to generate by itself a situation of preloading in the interior thereof so as to make the door lock unable to open, and consequently, the door handle must be first pulled outwards to and the pushed inward to release the preloading in order to achieve unlocking. In case of disasters of various forms, the door will be more difficult to open due to the tension and pushing of the crowd, and even cause more serious consequences.

### SUMMARY OF THE INVENTION

To achieve the above objective, the present invention provides a successive-preloading-release lock structure, which comprises:
a housing, wherein the housing comprises a receiving space, and the housing comprises an auxiliary receiving space;
an operation drive device, wherein the operation drive device is arranged in the receiving space of the housing, and the operation drive device comprises a control module, the control module comprising an output module, the control module comprising a solenoid valve, the solenoid valve being electrically connected to the output module, the solenoid valve comprising an extendible/retractable rod;
a positioning member, wherein the positioning member has a first end, the first end being arranged in the auxiliary receiving space of the housing, and the positioning member comprises a first support shaft, the first support shaft having a second end, the second end being connected to the housing, the positioning member comprising a first stop; and
a stopper member, wherein the stopper member is arranged in the receiving space of the housing, and the stopper member comprises a second support shaft, the second support shaft having a third end, the third end being connected to the housing, the stopper member being provided with a second stop, the second stop and the first stop being engageable with and retainable on each other, wherein the output module is operable to successively output pulses within one time period, so as to have the extendible/retractable rod successively hit the first stop for multiple times.

When preloading is induced in a lock assembly due to factors such as environment, making the second stop of the stopper member in mutual retaining engagement with the first stop of the positioning member to cause difficulty of unlocking and opening, the operation drive device can be operated to have the extendible/retractable rod successively hit, in an up-down direction, the positioning member for multiple times, in order to generate a gap to release the positioning member to allow the second stop to smoothly pass over the first stop, thereby achieving an effect of releasing the preloading and thus achieving the purpose of easily unlocking for door opening.

### BRIEF DESCRIPTION OF THE DRAWINGS

FIG. 1 is a schematic view showing the present invention in an assembled form.

FIG. 2 is a schematic exploded view of the present invention.

FIG. 3 is a schematic, partially exploded view of the present invention.

FIG. 4 is a schematic view showing a stopper member of the present invention is caused by preloading to get in retaining engagement with a positioning member.

FIG. 5 is a first schematic view illustrating successive multiple rounds of operation of releasing preloading according to the present invention.

FIG. 6 is a second schematic view illustrating successive multiple rounds of operation of releasing preloading according to the present invention.

FIG. 7 is a third schematic view illustrating successive multiple rounds of operation of releasing preloading according to the present invention.

FIG. 8 is a schematic view showing a control module of the present invention.

FIG. 9 is a schematic view showing a combination of a pulse generating circuit and a timing module according to the present invention.

FIG. 10 is a schematic view illustrating unlocking and door opening according to the present invention.

### DETAILED DESCRIPTION OF THE PREFERRED EMBODIMENTS

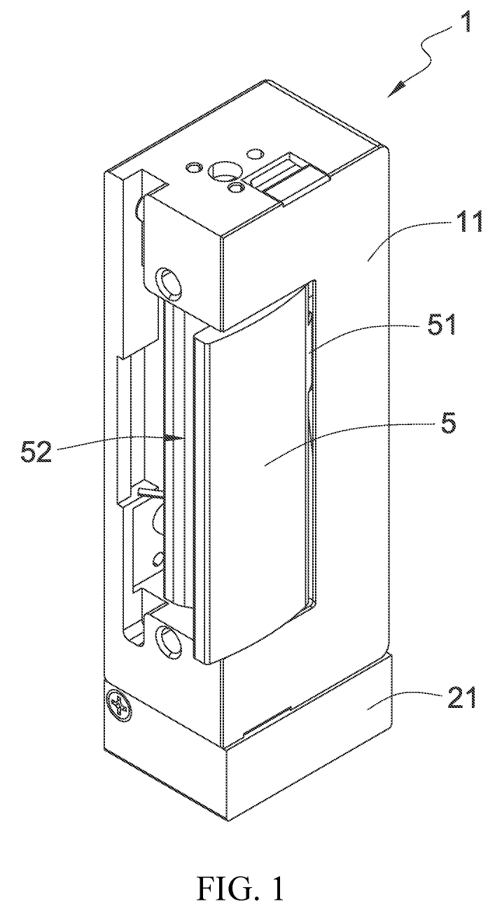

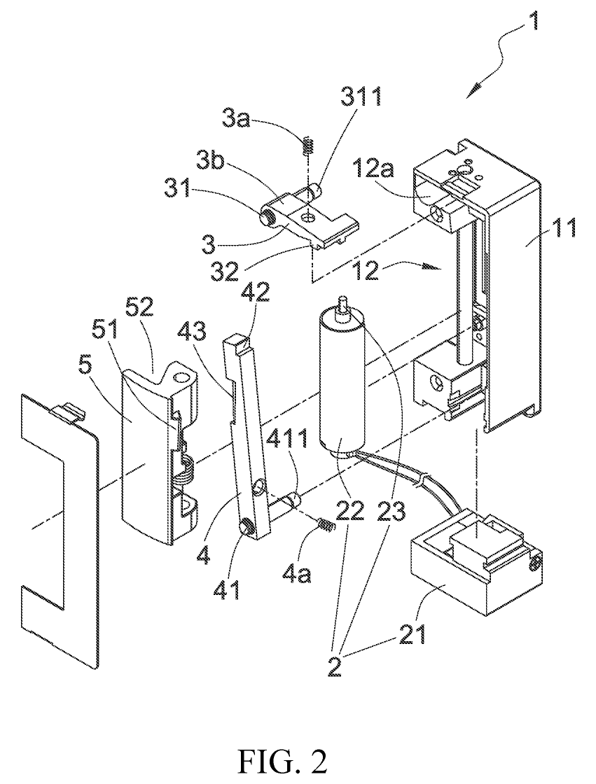

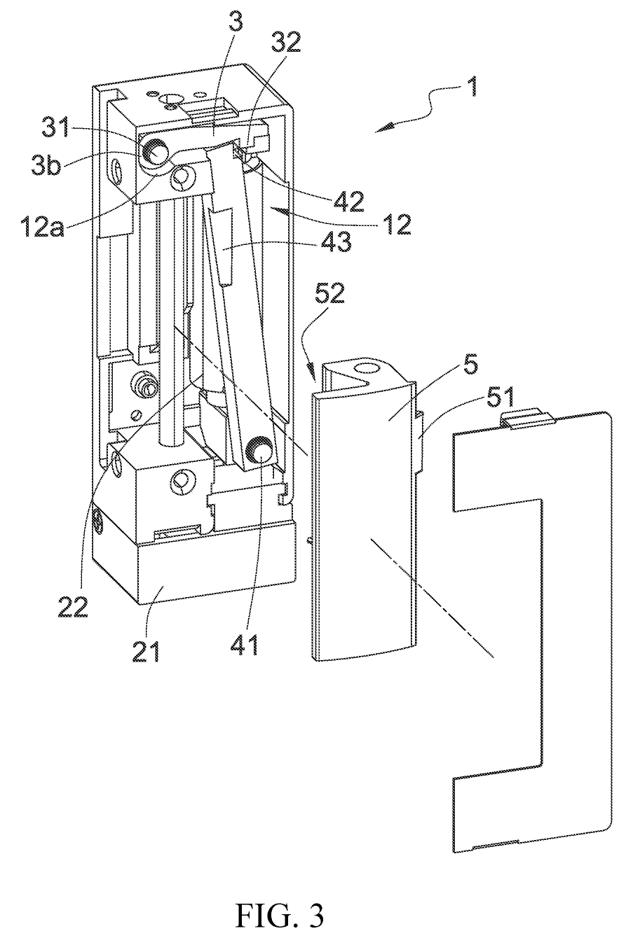

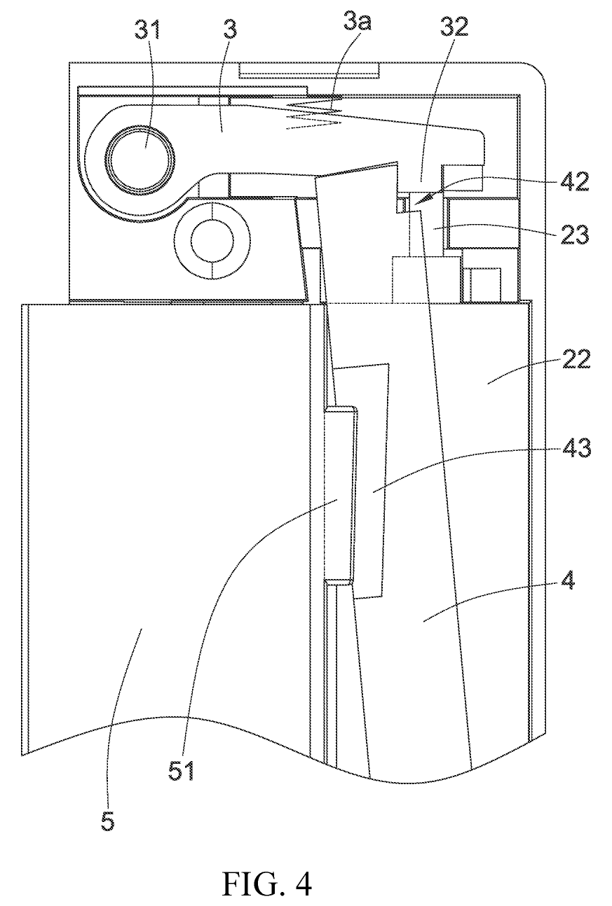

Referring to FIGS. 1 and 2, the present invention provides a successive-preloading-release lock structure, which comprises:
a housing 11, wherein the housing 11 comprises a receiving space 12, and the housing 11 comprises an auxiliary receiving space 12a;
an operation drive device 2, wherein the operation drive device 2 is arranged in the receiving space 12 of the housing 11, and the operation drive device 2 comprises a control module 21, the control module 21 being connectable to an external device, such as a card swiper or a switch, wherein the external device is not a technical feature of the present invention and will not be described in detail herein; the control module 21 is provided with a solenoid valve 22, and the solenoid valve 22 is electrically connected to the control module 21, and the solenoid valve 22 comprises an extendible/retractable rod 23;
a positioning member 3, wherein as shown in FIG. 3, the positioning member 3 has a first end 3b, the first end 3b being arranged in the auxiliary receiving space 12a of the housing 11, and the positioning member 3 comprises a first support shaft 31, the first support shaft 31 having a second end 311, the second end 311 being connected to the housing 11 (not shown in the drawings), and the first support shaft 31 extends through the positioning member 3, the positioning member 3 comprising a first stop 32, and referring to FIG. 4, the first stop 32 of the positioning member 3 is supported by the first support shaft 31 so as to rotate about a fulcrum defined by the first support shaft 31, the first stop 32 being a protrusion portion, and the positioning member 3 is arranged between the housing 11 and the extendible/retractable rod 23, the positioning member 3 being contactable and pushable by the extendible/retractable rod 23 of the solenoid valve 22; and
a stopper member 4, wherein the stopper member 4 is arranged in the receiving space 12 of the housing 11, and the stopper member 4 comprises a second support shaft 41, the second support shaft 41 having a third end 411, the third end 411 being connected to the housing 11 (not shown in the drawings), and the second support shaft 41 extends through the stopper member 4, the stopper member 4 being provided with a second stop 42, wherein the second stop 42 of the stopper member 4 is supported by the second support shaft 41 so as to rotate about a fulcrum defined by the second support shaft 41, the second stop 42 being a recessed portion, the second stop 42 and the first stop 32 being engageable and retainable on each other.

Referring to FIG. 2, a first elastic member 3a is arranged between the housing 11 and the positioning member 3. The control module is operable to output a signal to the solenoid valve, so as to cause the extendible/retractable rod 23 of the solenoid valve 22 to get into contact with and push the positioning member 3 to make the first stop 32 of the positioning member 3 rotate about a fulcrum defined by the first support shaft 31, to thereby compress the first elastic member 3a, so that an elastic force is accumulated in the first elastic member 3a for subsequent position restoration. A second elastic member 4a is arranged between the housing 11 and the stopper member 4. With a pressing portion 51 of a door stop 5 approaching and pressing against the stopper member 4, the second stop 42 of the stopper member 4 is caused to rotate about a fulcrum defined by the second support shaft 41, thereby compressing the second elastic member 4a, so that an elastic force is accumulated in the second elastic member 4a for subsequent position restoration. Further, the first elastic member 3a or the second elastic member 4a can be a spring.

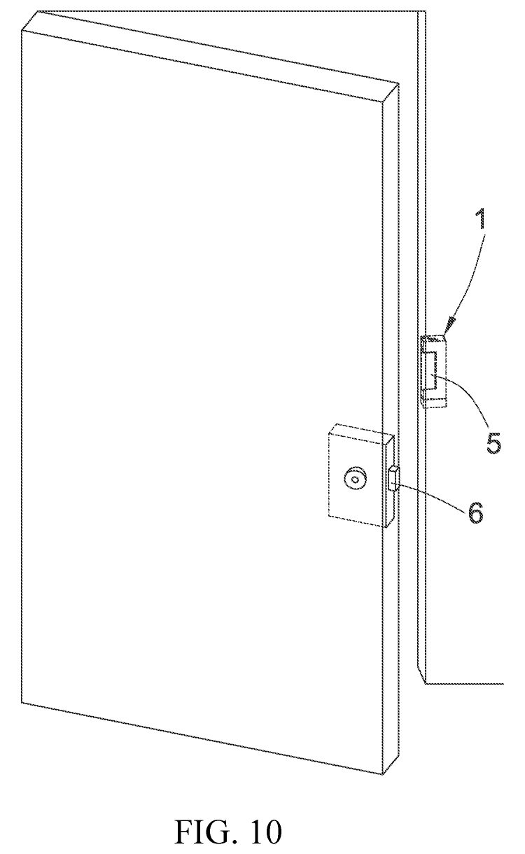

Referring to FIGS. 3 and 10, the door stop 5 comprises a door stop limiting portion 52 and the pressing portion 51, so that when a situation of preloading occurs in the present invention, the lock bolt 6 presses and pushes the door stop limiting portion 52 of the door stop 5, so that the pressing portion 51 of the door stop 5 is forced to press against the third stop 43 of the stopper member 4, resulting in the second stop 42 of the stopper member 4 being loaded on and becoming retaining engagement with the first stop 32 of the positioning member 3.

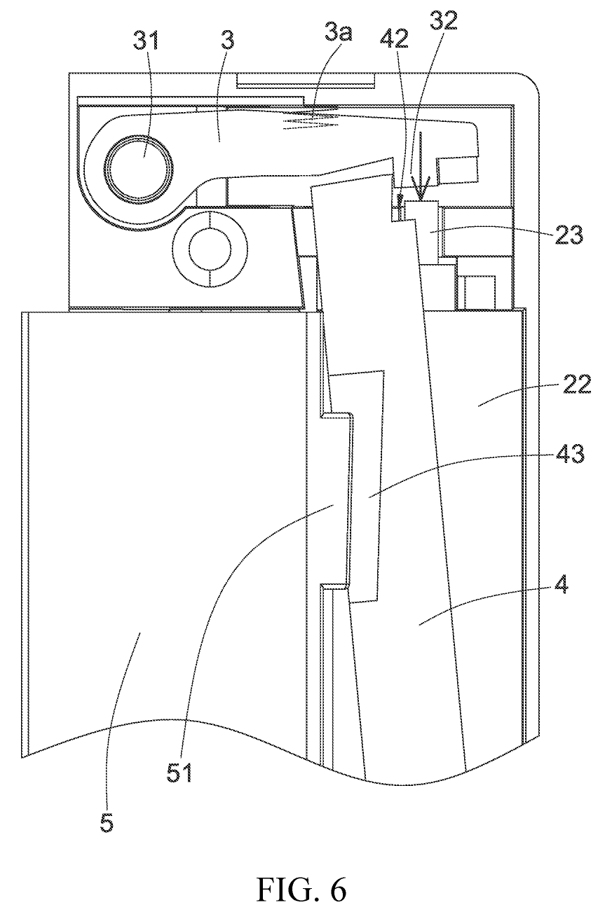

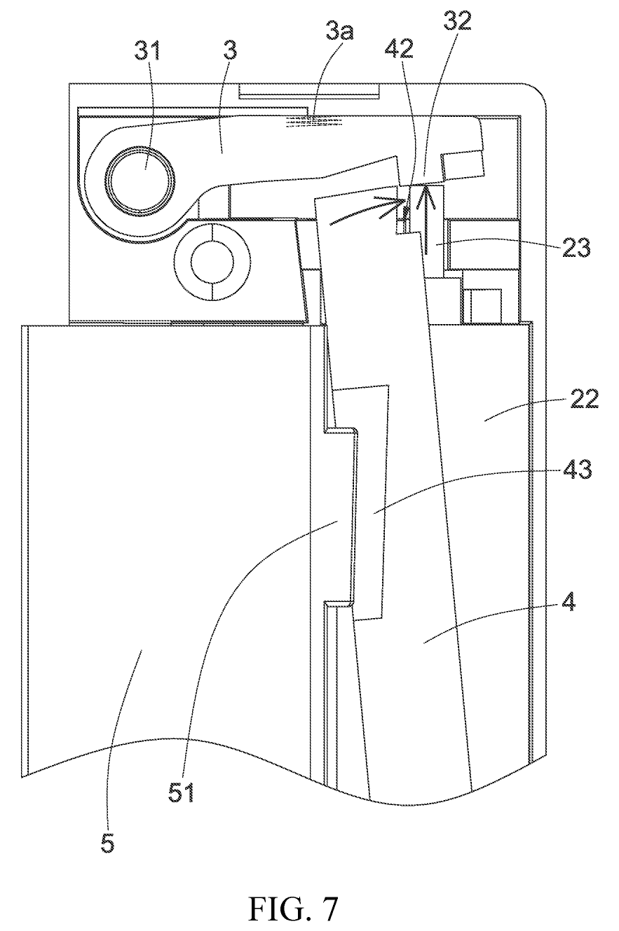

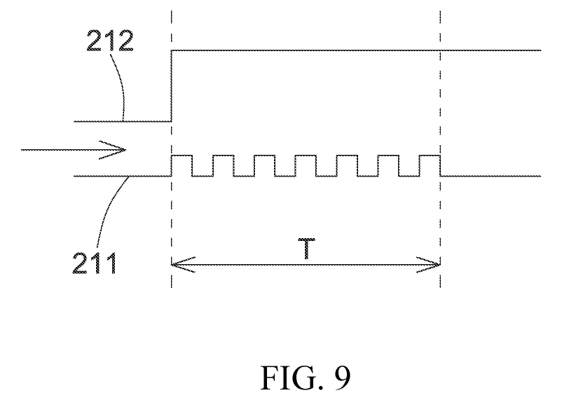

Referring further to FIGS. 6 and 7, a practical operation of the successive-preloading-release lock structure according to the present invention is such that the control module 21 of the operation drive device 2 is operated to output multiple pulse signals in one time period T, see FIG. 9, to transmit to the solenoid valve 22, so as to drive the extendible/retractable rod 23 of the solenoid valve 22 to successively extend and retract for multiple times in one time period T, thereby successively hitting the positioning member 3 for multiple times to release the second stop 42 of the stopper member 4 and the first stop 32 of the positioning member 3 that are stuck together due to the preloading from each other, and thus allowing the first stop 32 of the positioning member 3 to rotate and move about the fulcrum defined by the first support shaft 31, causing the first stop 32 to generate a gap and no longer in retaining engagement with the second stop 42, and as shown in FIG. 7, so as to allow the second stop 42 of the stopper member 4 to rotate about the fulcrum defined by the second support shaft 41 to have the lock bolt 6 easily separate from the door stop limiting portion 52, achieving the purpose of easily release the preloading and unlocking the door. The time period T can be a time interval in the order of several seconds.

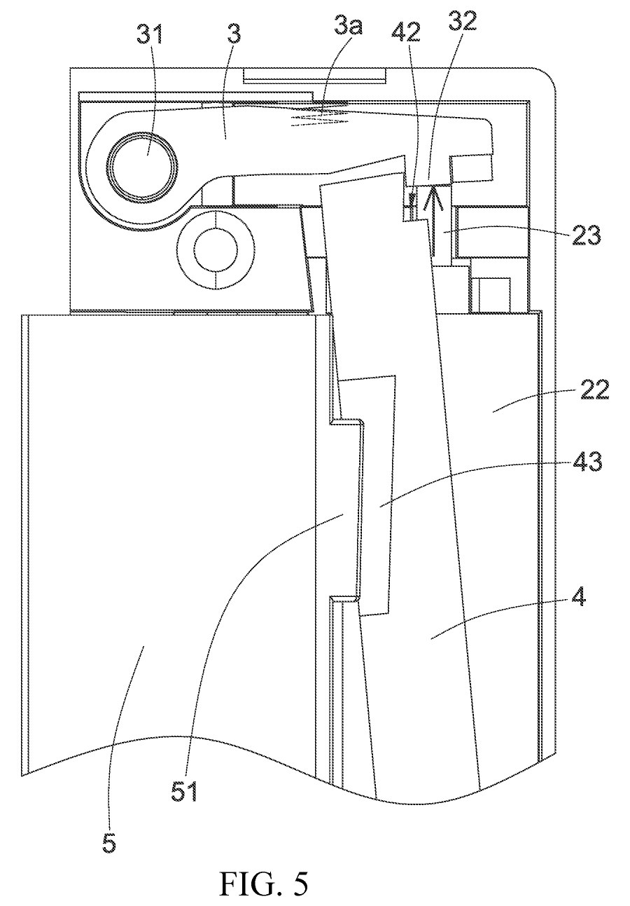

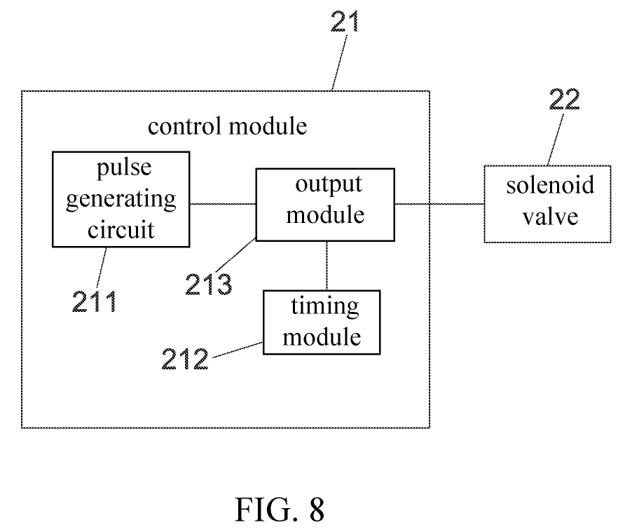

Referring to FIGS. 8 and 9, the operation drive device 2 comprises the control module 21, and the control module 21 comprises a pulse generating circuit 211, a timing module 212, and an output module 213. The pulse generating circuit 211 is electrically connected to the output module 213, and the timing module 212 is electrically connected to the output module 213. The control module 21 is electrically connected to the solenoid valve 22, and when the solenoid valve 22 receives an input of signal, the extendible/retractable rod 23 retract inward, and when no signal is input, the extendible/retractable rod 23 extends outward, and vice versa. Through the combination of the pulse generating circuit 211 and the timing module 212, the control module 21 can output, within one time period T, multiple successive signals to the solenoid valve 22, making the extendible/retractable rod 23 of the solenoid valve 22 hit the first stop 32 of the positioning member 3 successively multiple times within one time period T, so that as shown in FIGS. 5 and 6, the first stop 32 of the positioning member 3 that is supported by the first support shaft 31 is caused to rotate about the fulcrum defined by the first support shaft 31 and is thus moved thereby making the first stop 32 generate a gap that allows the second stop 42 to smoothly pass over the first stop 32, no longer retaining the second stop 42, achieving the purpose of easily releasing the preloading and unlocking the door.

In summary, referring to FIGS. 1 and 10, when preloading is induced in a lock assembly 1 due to factors such as environment, making the second stop 42 of the stopper member 4 in mutual retaining engagement with the first stop 32 of the positioning member 3 to cause difficulty of unlocking for door opening, the present invention uses the operation drive device 2 to make multiple successive hit, in an up-down direction, to the positioning member 3, in order to generate a gap to release the positioning member 3, to thereby achieve an effect of releasing the preloading and thus achieving the purpose of easily unlocking for door opening.

I claim:

1. A successive-preloading-release lock structure, comprising:
a housing, wherein the housing comprises a receiving space, and the housing comprises an auxiliary receiving space;
an operation drive device, wherein the operation drive device is arranged in the receiving space of the housing, and the operation drive device comprises a control module, the control module comprising an output module, the control module comprising a solenoid valve, the solenoid valve being electrically connected to the output module, the solenoid valve comprising an extendible/retractable rod;
a positioning member, wherein the positioning member has a first end, the first end being arranged in the auxiliary receiving space of the housing, and the positioning member comprises a first support shaft, the first support shaft having a second end, the second end being connected to the housing, the positioning member comprising a first stop; and
a stopper member, wherein the stopper member is arranged in the receiving space of the housing, and the stopper member comprises a second support shaft, the second support shaft having a third end, the third end being connected to the housing, the stopper member being provided with a second stop, the second stop and the first stop being engageable with and retainable on each other, wherein the output module is operable to successively output pulses within one time period, so as to have the extendible/retractable rod successively hit the first stop for multiple times.

2. The successive-preloading-release lock structure according to claim 1, wherein a first elastic member is arranged between the housing and the positioning member.

3. The successive-preloading-release lock structure according to claim 1, wherein a second elastic member is arranged between the housing and the stopper member.

4. The successive-preloading-release lock structure according to claim 1, wherein the stopper member comprises a third stop.

5. The successive-preloading-release lock structure according to claim 1, wherein the third stop is provided with a slope surface.

6. The successive-preloading-release lock structure according to claim 1, wherein the positioning member is arranged between the housing and the extendible/retractable rod of the solenoid valve.

7. The successive-preloading-release lock structure according to claim 1, further comprising a door stop, the door stop comprising a pressing portion.

8. The successive-preloading-release lock structure according to claim 1, wherein the first stop comprises a protruding portion.

9. The successive-preloading-release lock structure according to claim 1, wherein the second stop comprises a recessed portion.

10. The successive-preloading-release lock structure according to claim 1, wherein the control module comprises a pulse generating circuit and a timing module, the pulse generating circuit being electrically connected to the output module, the timing module being electrically connected to the output module.
